(19) United States
(12) Patent Application Publication
(10) Pub. No.: US 2002/0049747 A1
(43) Pub. Date: Apr. 25, 2002

(54) Method for integrating and accessing of heterogeneous data sources

(76) Inventors: Shigekazu Inohara, Tokyo (JP); Itaru Nishizawa, Koganei (JP); Akira Shimizu, Kokubunji (JP)

Correspondence Address: Antonelli, Terry, Stout & Kraus, LLP, Suite 1800, 1300 North Seventeenth Street, Arlington, VA, 22209, US

(21) Appl. No.: 09/791,808

(22) Filed: Feb. 26, 2001

(30) Foreign Application Priority Data
Jun. 6, 2000 (JP) 2000-174201

(51) Int. Cl. G06F 7/00

(52) U.S. Cl. 707/2

(57) ABSTRACT

A method for integrating data, stored not only in a relational database management system but also in data sources such as legacy application programs or tertiary storage where inquiry cannot be executed efficiently, and for performing inquiry quickly. A distributed index for use by a data source is generated in a database hub in advance, and a distribution index application unit converts and disassembles an inquiry using the distributed index.

### BACKGROUND OF THE INVENTION

The present invention relates to a computer system, and more particularly to a data access method for use in a data processing system that processes a user inquiry using one or more databases.

Today, many types of data are stored in a computer system of a company. The various types of data, each has its own use, have been added to the computer system as the company grows. As the restrictions on the industry sectors are removed, more companies start new business. In many cases, the introduction of new business involves new data that is stored in different ways and different formats. For example, data is stored in a database in a relational database, in a flat file in a file system, in a magneto optical disk archive, or in a data file of a spreadsheet software program. In this specification, data storage objects using these data storage methods or formats are collectively called a data source. For a prior art data source, see for example M. M. Astrahan et al. “System R: Relational Approach to Database Management”, ACM Transactions on Database Systems, Vol. 1, No. 2, June 1976, 97-137.

As more regulations are removed, more companies are trying to provide new, unique services to their customers to attract more customers. In that case, an increasing need arises to analyze data on the past company activity and customer trends accumulated in many data sources. This leads a large number of companies to build data warehouses or data marts.

Building a data warehouse or a data mart requires data, accumulated in many data sources, to be integrated into one logical database. In addition to building a data warehouse or a data mart that will be used as a basis of analysis, the logical integration of conventional data sources is necessary for the company to start a new business in a short period and to become more competitive. This is because logically integrated data sources allow the companies to quickly develop application programs (applications) for new businesses.

When the data source is a database management system (DBMS), a system such as a “database hub” that gives an integrated access to the DBMS is sometimes used between the data source and applications. For a prior art database hub, see for example Sushil V. Pillai et al. “Design Issues and Architecture for a Heterogeneous Multidatabase system”, proceedings of the 15^{th} annual conference on Computer Science, 1987, pp. 74-79.

The database hub accepts an inquiry (typically, an SQL (Structured Query Language) coded inquiry) from an application and disassembles/translates the inquiry for transmission to the DBMS. The database hub issues the disassembled/translated inquiry to the DBMS, collects data necessary for creating an inquiry result from the DBMS, gets a final result answering the inquiry that was issued from the application, and returns the result to the application.

Data integration using a database hub is configured as described below.

(1) User application (UAP): A program that processes data integrated by a database hub.

(2) Database hub: A database hub integrates one or more data sources and provides the integrated data source to a UAP as one database. For an inquiry from a UAP requesting access to a plurality of data sources, the database hub uses data from the plurality of data sources to generate an inquiry result that will be returned to the UAP.

(3) Data source: A data source holds data to be integrated.

Although a database hub and data sources are on separate computers in most cases, they may reside on the same computer.

For other known technologies relating to the present invention, reference may be made to U.S. Pat. Nos. 5,542,078, 5,737,732, and 5,555,409. U.S. Pat. No. 5,542,078 relates to accessing and integrating of non-object oriented data stores with object applications. U.S. Pat. No. 5,737,732 relates to storing, indexing and retrieving of digital information stored in a memory. U.S. Pat. No. 5,555,409 relates to data management systems and methods including creation of composite views of data.

### SUMMARY OF THE INVENTION

Although a relational database management system (RDBMS) is one of data sources, other data sources are also used. The other data sources include a hierarchical database, a flat file in a file system, a file in a magneto optical disk archive, and a spreadsheet software data file.

These data sources include basic business data that existed before the introduction of the RDBMS or data that is too much to be recorded in the RDBMS (not suitable for storing in terms of cost effectiveness). However, from the strategic viewpoint, this type of data is more important in many cases than data stored in the RDBMS.

However, most of these data sources cannot be accessed with the statements coded in SQL, a database inquiry language widely used today for accessing RDBMS. On the other hand, the database hub described above disassembles/translates SQL coded inquiries assuming that the data source is an RDBMS, that is, the data source can be processed efficiently by SQL.

Therefore, when the data source does not accept SQL, access via the database hub requires the user to specify a special search condition (a condition that the result records must satisfy) to get the desired result. The special search condition is key information for specifying data in the data source. This makes it difficult for the user (application) to make a flexible search, increasing the load of application development. In addition, though this restriction may be applied to routine jobs, it is difficult to apply this restriction to data processing in which non-routine inquiry jobs are dominant.

In addition, if the user can access the data source via SQL but if access efficiency is low, information base integration via a database hub is sometimes too inefficient to be used practically in daily jobs. This is because a multiple-item search, such as a range search, requires access to almost all items in the data source. Therefore, except in a very small configuration, it is difficult to achieve allowable performance.

In view of the foregoing, it is an object of the present invention to provide technology for integrating information bases whether the data source is an RDBMS or not.

Therefore, a specific problem to be solved by the present invention to allow the user to access a non-RDBMS data source as efficiently as an RDBMS data source even when the user accesses a non-RDBMS data source via the interface (SQL) provided for an RDBMS data source.

To solve the above problem, a part of data is obtained from the non-RDBMS data source for use as an index that is held in the database hub as will be described later. This index is called a “distributed index” to distinguish it from an index used internally in the conventional RDBMS.

Although there are many non-RDBMS data sources, particular emphasis is placed on data sources in which strategically important data is stored. Those strategically important data sources include legacy application programs (legacy AP) and tertiary storage such as a tape archive and a magneto optical disk archive. However, creating a distributed index described above for those data sources takes a long time.

Therefore, another specific problem to be solved by the present invention is to efficiently create a distributed index in non-RDBMS data sources, such as legacy applications or tertiary storage, in which creating a distributed index may take long.

A distributed index, which is maintained in the database hub, is composed of data obtained from a data source. Therefore, when the data source is updated, the index must also be updated accordingly.

Therefore, still another specific problem to be solved by the present invention is to provide a database hub manager with a method for managing an index created for a database hub.

Furthermore, some data sources sometimes contain too much data to be stored in an RDBMS. An index in such data sources, unlike an index in a normal RDBMS, cannot even contain information on all records in some cases. For example, extracting the columns required for creating an index for several T-bytes (terabytes) of data stored in a magneto optical disk archive would require scores of G-bytes of data to several hundreds of G-bytes of data. On the other hand, in a system where such a huge amount of data is processed, a search is usually made, not for all records, but for a particular search targets. Therefore, still another specific problem to be solved by the present invention to select records to be included in a distributed index and to reduce the amount of data in the distributed index.

To solve the first-mentioned specific problem described above, a system according to the present invention retrieves a part of data from a non-RDBMS data source for use as an index and stores the retrieved data in the database hub. This index is herein called a distributed index to distinguish from the index internally used in the conventional RDBMS. The distributed index contains data associating search conditions for the data source with record specifications in the data source.

A data source usually has one or more data items to be used as a key. A key is a piece of information that specifies a meaningful unit of data (called a record). In many cases, a key uniquely identifies a record. In addition, a data source usually provides the user with means for quickly accessing a key-specified record.

For example, assume that there is a data source that is a customer management application for managing customer data to which customer IDs are assigned. In this case, a record (a set of customer ID, name, address, age, telephone number, company address, and so on) in the customer data may be identified with the customer ID as the key.

Also assume that transaction history data is stored in the time-series manner on a magneto optical disk archive. In this case, time-of-day information, if included in each piece of transaction information, may be used as the key. In this example, whether or not time-of-day information uniquely identifies a particular piece of transaction information depends on how time-of-day information is assigned. Anyway, using time-of-day information as the key quickly gives the user one piece of transaction information (or several pieces of transaction information generated at the same time).

A distributed index contains data associating a search condition for a data source with the key of the data source. More specifically, the distributed index contains data composed of data groups to be searched for and keys. Applying a search condition to the distributed index gives the keys satisfying the search condition. Accessing a data source using this key group gives quick access to the data source.

For example, assume that the customer management application provides the user with only one interface “get record with customer ID”. Also assume that a user application program (UAP) issues to the database hub a search condition inquiry requesting to search for “customers from 30 to 40 in age”. To process this inquiry, the database hub passes all customer IDs to the customer management application to obtain all customer records. After that, the search condition is applied to all customer records to get the inquiry result. Therefore, the database hub need to obtain a large number of records from the customer management application that is a data source. This method significantly degrades inquiry execution efficiency.

The distributed index according to the present invention allows the database hub to apply the search condition “customers from 30 to 40 in age” to the distributed index to obtain the customer IDs satisfying this condition. Then, the obtained customer IDs are issued to the customer management application to get the inquiry result. In this case, only the customer IDs satisfying the condition “customers from 30 to 40 in age” need be issued to the customer management application. Therefore, the processing amount of the customer management application and the amount of communication between the database hub and the customer management application are greatly reduced.

If the database hub accesses all the records in the data source when creating a distributed index, a large amount of communication is necessary between the database hub and the data source. This is not desirable because it gives a heavy load to the network and the data source when creating the distributed index. To avoid this problem, the system according to the present invention places an index creation program in the computer on which the data source exists. This index creation program creates the distributed index of the data source and transfers the completed distributed index to the database hub. This requires the database hub to communicate with the data source only once when creating the distributed index, significantly reducing the network load. Reduction in the network load, in turn, reduces the network processing load of the computer on which the data source resides.

Unlike an index internally held by the RDBMS, a distributed index is not updated as the data source is updated. This means that means by which the database hub user or manager uses, manages, and operates the distributed index appropriately is necessary. Therefore, the system according to the present invention provides two interfaces: one is an interface via which a distributed index to be used (or not to be used) by the user is specified, and the other is an interface via which a distributed index is created and is made to correspond to the current data source.

As described above, some data sources sometimes contain too much data to be stored in an RDBMS. An index in such data sources, unlike an index in a normal RDBMS, cannot even contain information on all records in some cases. For example, extracting the columns required for creating an index for several T-bytes (terabytes) of data stored in a magneto optical disk archive would require scores of G-bytes of data to several hundreds of G-bytes of data. To avoid this problem, the system according to the present invention uses a distributed index that contains keys of not all records but some records. The records to be included in the distributed index are selected either using a particular search condition or randomly.

The means described above enable the system according to the present invention to provide the user with data, stored not only in an RDBMS data source but also in legacy applications or tertiary storage, as if the data was in one database. The means also enable the system to achieve high inquiry performance.

### BRIEF DESCRIPTION OF THE DRAWINGS

FIG. 1 is a block diagram showing the overall configuration of an embodiment;

FIGS. 2A and 2B are diagrams showing the configuration of data structures;

FIG. 3 is a flowchart showing the processing of distributed index application;

FIG. 4 is a flowchart showing the processing of inquiry using a distributed index;

FIG. 5 is a flowchart showing the processing of a distributed index manager during distributed index creation; and

FIG. 6 is a flowchart showing the processing of an index creation program during distributed index creation.

### DESCRIPTION OF THE EMBODIMENTS

Some embodiments of the present invention will be described in detail with reference to the attached drawings.

[1] Overall structure

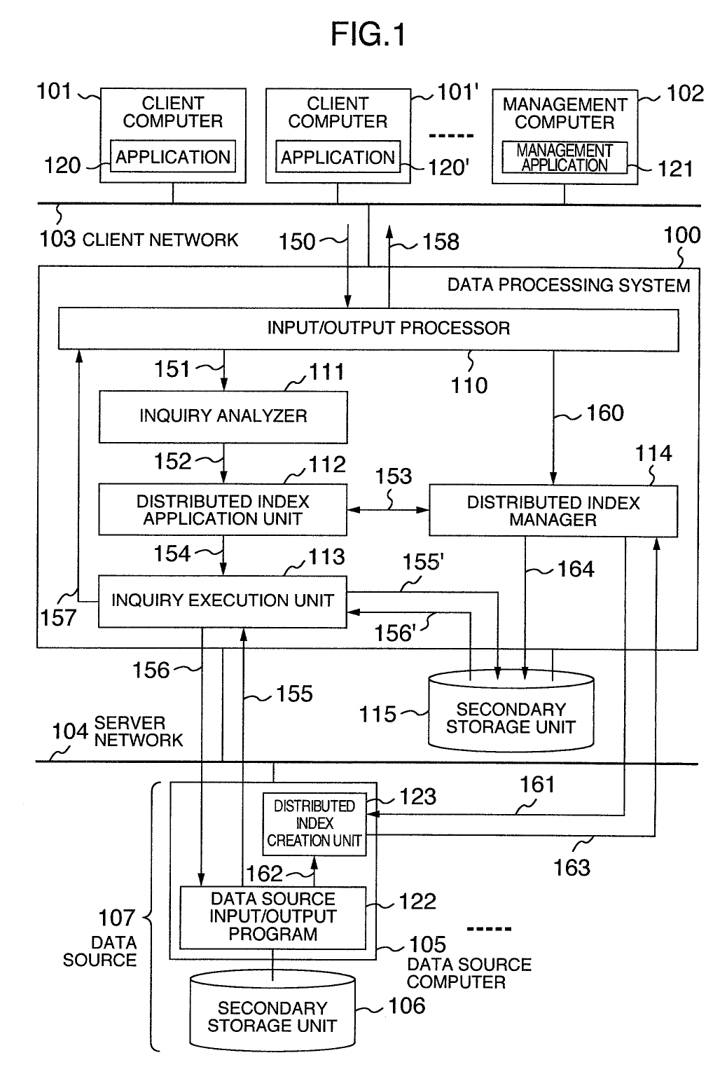

Referring to FIG. 1, the overall configuration of an embodiment of the present invention will be described.

FIG. 1 is a diagram showing a computer system used for the embodiment. This embodiment is a computer system in which one or more computers (data processing system 100, one or more client computers 101, 101′ and so on, a management computer 102, one or more data source computers 105) are interconnected via a client network 103 and a server network 104.

The client network 103 and the server network 104 may be a local area network (LAN) used for an organization (company, school, and so on) or its division or may be a wide area network (WAN) or its part connecting a plurality of geographically distributed locations. These networks may also be a network connecting computers or a network connecting processor elements in a parallel computer. The client network 103 and the server network 104 may be the same computer.

The data processing system 100, the client computers 101, 101′ and so on, the management computer 102, and the data source computer 105 may be any computer such as a personal computer, a workstation, a parallel computer, a large computer, or a small portable computer.

Applications 120, 120′ and so on, which execute user processing, run on the client computers 101, 101′ and so on. The application 120 issues a reference, update, or inquiry request to a database as necessary. In this embodiment, these requests are assumed to be coded in SQL.

The data source computer 105 holds the data of a data source and references or updates data whenever a program issues an access request to data. The reference and update of data in the data source is done by a data source input/output program 122. The data source input/output program 122 may be what we call a legacy application. Usually, the data source computer 105 stores data on a secondary storage unit 106 for managing it. The data source computer 105, secondary storage unit 106, data source input/output program 122, and data stored therein are called generically as a data source 107. The secondary storage unit 106 may be any storage medium, generally called tertiary storage, such as a magneto optical disk archive.

The data in the data source is one or more meaningful units of data. Each unit is called a record as in the RDBMS. For example, in a transaction history data source, one transaction may be regarded as a record. For a record composed of a plurality of parts, a part that may be specified as an argument of a search condition or an output item is called a column as in the RDBMS. For example, “transaction time” or “transaction item name” included in one transaction history record is regarded as a column. For example, assume that the data source input/output program 122, which is a legacy application, associates “customer ID” with “address”, “name”, “age”, and “occupation”. In this case, “customer ID, address, name, age, occupation” may be considered one record, while each of “customer ID”, “address”, “name”, “age”, and “occupation” may be considered a column.

The data processing system 100 receives a first inquiry issued from the client computers 101, 101′, and so on, creates one or more second inquiries as necessary for transmission to the data source 107, references or updates data as specified by the first inquiry, and then returns the result to the program from which the first inquiry was issued. That is, the data processing system 100 acts as a database hub that makes an integrated access to the databases held in the data source 107 and provides the client computers 101, 101′, and so on with an integrated database.

The management computer 102 executes a management application 121. The management application 121, a program that manages the data processing system 100, is used typically by a manager who manages the data processing system 100 or the whole system shown in FIG. 1.

The data processing system 100 comprises an input/output processor 110, an inquiry analyzer 111, a distributed index application unit 112, an inquiry execution unit 113, a distributed index manager 114, and a secondary storage unit 115. These components are outlined here. Their operations will be detailed later.

The input/output processor 110 accepts an inquiry request from the client computers 101, 101′ and so on or from management computer 102 and, at the same time, returns an answer to the request.

The inquiry analyzer 111 performs lexical analysis, syntax analysis, and semantic analysis of the inquiry accepted by the input/output processor 110. The inquiry analyzer 111 performs standard conversion of the inquiry condition as necessary and generates a parse tree from the inquiry.

The distributed index application unit 112 uses the parse tree created by the inquiry analyzer 111 to convert the received inquiry to allow it to use a distributed index. In this case, which index to use must be decided. This decision is made using management information on each distributed index held by the distributed index manager 114. And, the distribution index application unit 112 generates a procedure for a sequence of operations (execution plan) for getting an inquiry result. For a relational database, the sequence of operations includes selection, projection, join, grouping, and sorting. The execution plan is a data structure describing which of these operations is to be performed on which data in which data source 107 in which order.

The inquiry execution unit 113 executes the execution plan generated by the distributed index application unit 112. The inquiry execution unit 113 issues an inquiry to the data source 107 to request it to execute a part or all of the operations. Or, the inquiry execution unit 113 itself executes a part or all of the sequence of operations for data obtained from the data source 107.

The distributed index manager 114 interprets a management request received by the input/output processor 110, performs operation on the distributed index included in the management request, and stores obtained results on the secondary storage unit 115. In addition, the distributed index manager 114 holds information on the distributed index to help the distributed index application unit 112 decide which distributed index to apply.

The overall configuration of the embodiment is as described above.

[2] Data structure

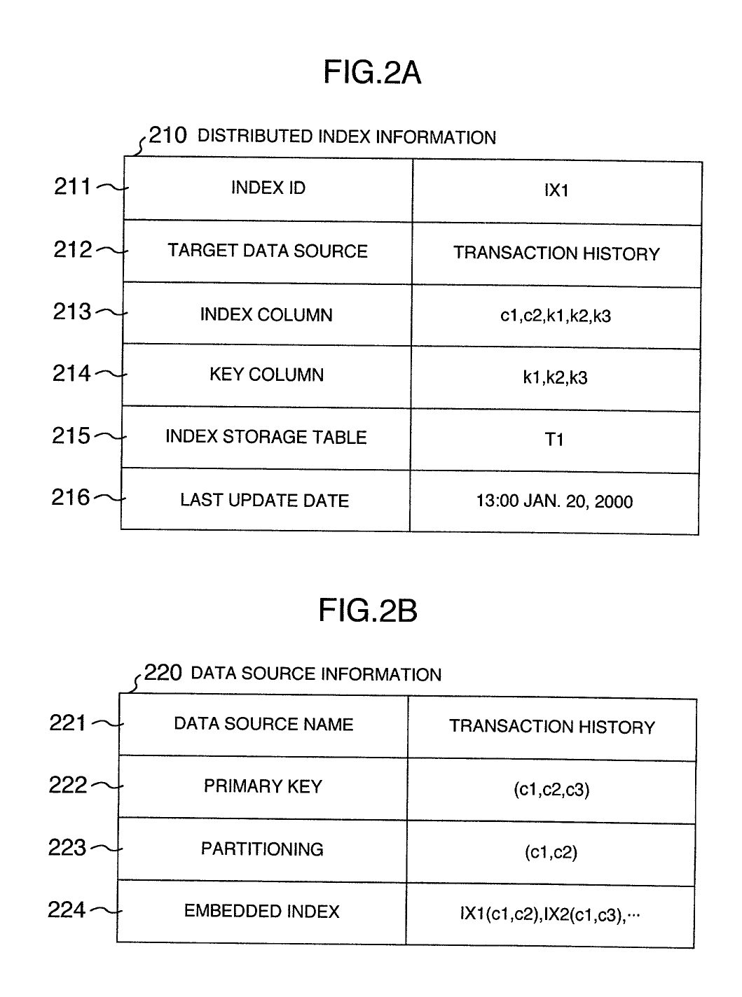

The data structures used in implementing a distributed index will be described with reference to FIG. 2A and 2B.

Primarily, two types of data structures are used.

Distributed index information 210 contains information on a distributed index held by the data processing system 100. The distributed index information 210 shown in FIG. 2A is one example of distributed index information. The data processing system 100 has one or more units of such information.

An index ID 211, the name of a distributed index, uniquely identifies each distributed index.

A target data source 212 is a data source from which the distributed index is created. It corresponds to a data source name 221 of data source information 220 that will be described later.

An index column 213 is a group of columns used by the distributed index. The distributed index application unit 112 uses the index column 213 to check to see if a search condition is to be evaluated with the distributed index.

A key column 214 is the key of the data source corresponding to the distributed index. When a search condition is evaluated using the distributed index, the key column 214 indicates the columns used to specify records to be used in inquiring into the data source. The set of columns of the key column 214 is included in the set of columns of the index column 213.

An index storage table 215 is the name of the distributed index stored in the secondary storage unit 115. The inquiry execution unit 113 accesses the index storage table 215 to evaluate a search condition using the distributed index.

A last update date 216 is the time the distributed index was updated last (created last from the data source).

Data source information 220 contains information on the data source 107. The data source information 220 shown in FIG. 2B is one example of data source information. The data processing system 100 has one or more units of such information.

The data source name 221 uniquely identifies a data source.

A primary key 222 is the primary key of the data source. The primary key is one or more columns used to access the data source. The records in the data source may be referenced with the primary key as the argument (in this specification, getRecord (primary key)). Usually, the primary key is composed of one or more columns arranged in the order in which they are stored. Primary key information is used as hint information when automatically creating the distributed index.

Partitioning 223 is information on how to partition the data source (partitioning information). A large data source is partitioned into a plurality of data sources before being stored on a plurality of secondary storage units. This partitioning increases the parallel processing level of the secondary storage units and efficiently allocates space required for the data source. This is called partitioning. It is known that accessing data with the data source division method in mind significantly reduces the execution time. Division method information is also used as hint information for automatically creating the distributed index.

An embedded index 224 contains information on the indexes defining the data source. It is known that accessing data according to the order defined in the index significantly reduces the execution time. The information on the embedded index is also used as hint information for automatically creating a distributed index.

[3] Application of a distributed index to an inquiry

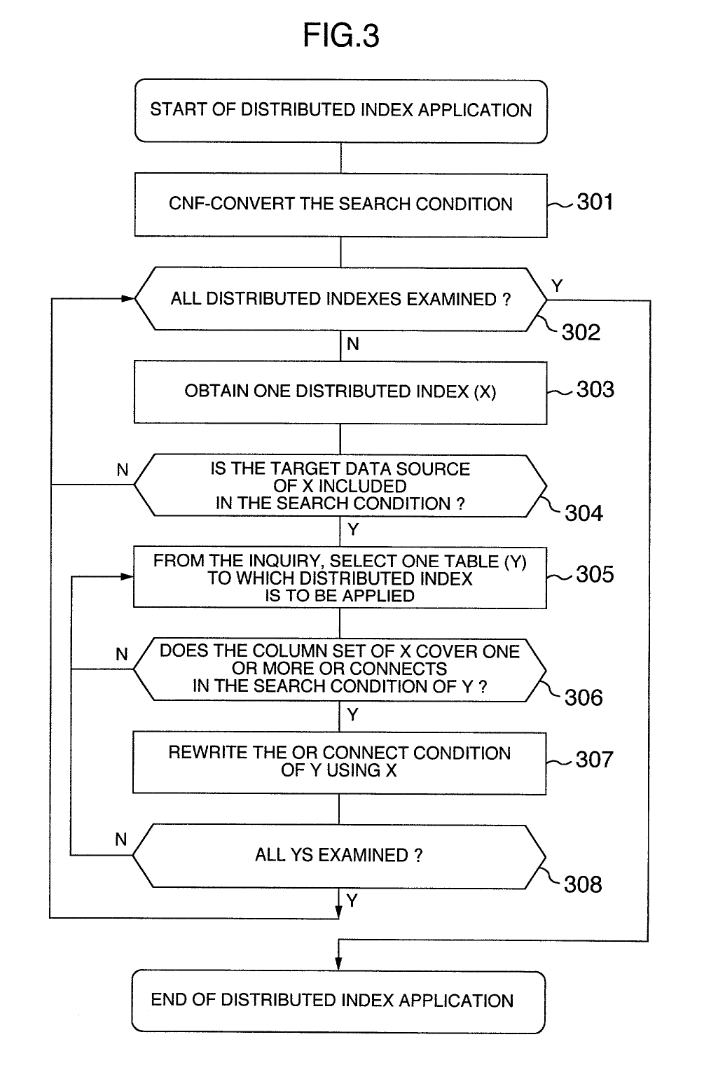

Referring to FIGS. 1 and 3, how the distributed index application unit 112 applies a distributed index to an inquiry will be described.

A first inquiry issued by the application 120 is sent to the input/output processor 110 of the data processing system 100 via the client network 103 (150). The input/output processor 110 checks the inquiry request to see if it is from the application or from the management application. According to the checking result, the input/output processor 110 sends the request to the inquiry analyzer 111 (151) or to the distributed index manager 114 (160).

Upon receiving the first inquiry, the inquiry analyzer 111 performs lexical analysis, syntax analysis, and semantic analysis. Through the sequence of processing, the inquiry analyzer 111 generates a first parse tree from the first parse tree. Because lexical analysis, syntax analysis, and semantic analysis are the same as those executed by a compiler or a database management system, they are not detailed here.

The inquiry analyzer 111 sends a first parse tree to the distributed index application unit 112 (152).

The distributed index application unit 112 checks the first parse tree to see if a distributed index is applicable. This is the processing shown in FIG. 3.

The steps shown in FIG. 3 are the steps for processing the search condition of the inquiry. The search condition refers to a specification for selecting a group of records from the data source. In the SQL, the search condition is specified by the WHERE clause, the HAVING clause, and so forth.

In step 301, the search condition is CNF-converted. A CNF (Conjunctive Normal Form) is a form generated by OR-connecting the elements of a search condition and then AND-connecting the connected elements. For example, “(c1=10 and c2=20) or c3=30” is CNF-converted to “(c1=10 or c3=30) and (c2=20 or c3=30)”. All the result records satisfy the OR connect conditions of the search condition that has been CNF-converted. (In the above example, “c1=10 or c3=30” and “c2=20 or c3=30” are OR connect conditions).

In step 302, a check is made if all distributed indexes in the data processing system 100 have been examined for the search condition. If all distributed indexes have been examined (Y), the distributed index application processing is completed.

In step 303, one distributed index is retrieved. In the description below, this distributed index is called X.

In step 304, the target data source 212 in the distributed index information 210 corresponding to X is referenced ((153)) to obtain the target data source of X. The search condition is checked to see if the target data source of X is included in the search condition. If the target data source is included in the search condition (Y), control is passed to step 305; if not (N), control is passed to step 302.

In step 305, one data source is selected from the target data sources of X included in the search condition. In the description below, the data source selected in this step is called Y. In this step, the possibility that one data source is referenced multiple times in one inquiry is taken into consideration. For example, in the inquiry “SELECT X FROM T1 A, T1 B WHERE A.C1=B.C2”, the data source T1 appears twice under the name of A and B.

In step 306, for each OR connect condition included in the search condition, a check is made if the column set of the data source Y used in the OR connect condition is included in the column set of the distributed index X. If it is included (Y), control is passed to step 307; if not (N), control is passed to step 305. Note that the column set of the distributed index X is stored in the index column 213 of X.

In step 307, the OR connect condition included in the column set of the distributed index X is rewritten to a search condition using X. More specifically, the inquiry is rewritten to an inquiry in which the search condition initially applied to T1 is applied to the distributed index X to obtain a key (X.key) and then access is made to T1 using the key set to obtain the result record. For example, if the index column 213 of X includes T1.C1, then “SELECT X FROM T1, T2 WHERE T1.C1=10” is rewritten to “SELECT X FROM T1, T2 WHERE T1.key in (SELECT X.key FROM X WHERE X.C1=10)”.

In step 308, control is passed to step 305 or step 302 according to whether all Ys have been examined. The steps are repeated.

The steps described above rewrite a received inquiry to an inquiry using a distributed index.

Returning to FIG. 1, the rest of the processing performed by the distributed index application unit 112 will be described. The distributed index application unit 112 optimizes the inquiry using the first parse tree received from the inquiry analyzer 111 and creates the execution plan of the first inquiry. In some cases, in addition to the first inquiry operation instruction, an additional inquiry operation instruction must be obtained. For example, an additional inquiry operation instruction must be obtained when the number of records of the table is determined in the course of cost-base optimization. In this case, the inquiry sort definition is searched for using this number of records and a new inquiry operation specification is obtained. How an inquiry operation instruction is obtained in this case is not described here, because it is performed in the same manner as the inquiry processing described above.

The execution plan of the first inquiry is created through cost-base optimization. Cost-base optimization, which is described in reference document 1 and so on, is not detailed here.

An example of the execution plan (first execution plan) generated by the distributed index application unit 112 is given below. It is a tree expressed by the list representation below. (database-hub-join [left.c1=right.c2 and left.c3<10, output left.c1, right.c2, left.c1+left.c3] (join at DBMS1 [left.c1<10 and left.c1=right.c4, output left.c1, left.c3] (selection at DBMS1 CustomerTable [1990<year and year<1999, output c1, c3])(selection at DBMS1 ProductTable [1000<price and price<2000, output c4])) (selection at DBMS2 OrderTable [1990<year and year<1999, outputc2])). This execution plan represents a sequence the following processing. “(1) selection processing is performed for CustomerTable in DBMS1 with the search condition ‘1990<year and year<1999’ and columns c1 and c3 are output through projection, (2) selection processing is performed for ProductTable in DBMS1 with the search condition ‘1000<price and price<2000’ and column c4 is output through projection, (3) selection processing is performed for OrderTable in DBMS2 with the search condition ‘1990<year and year<1999’ and column c2 is output through projection, (4) join processing is performed in DBMS1 with the join condition ‘left.c1<10 and left.c1=right.c4’ (assuming that the intermediate result of (1) is left and that the intermediate result of (2) is right) and columns c1 and c3 are output through projection, (5) join processing is performed in the data processing system 100 with the join condition ‘left.c1=right.c2 and left.c3<10’ (assuming that the intermediate result of (4) is left and that the intermediate result of (5) is right) and left.c1, right.c2, left.c1+left.c3 are output through projection”.

The distributed index application unit 112 sends the generated first execution plan to the inquiry execution unit 113 (154).

The inquiry execution unit 113 executes the first inquiry using the first execution plan received from the distributed index application unit 112. The inquiry execution unit 113 processes the first execution plan described above in the bottom-up order, that is, in order of steps (1), (2), (3), (4), and (5). (More precisely, steps (1), (2), and (3) may be executed in parallel). After the inquiry execution unit 113 executes all steps defined by the execution plan and obtains the final result of the first inquiry, the result is returned, via the input/output processor 110, to the application 120 from which the first inquiry was issued (155, 155′, 156, 156′, and 157).

The flow of inquiry processing including distributed index application is as described above.

[4] Execution of an inquiry using a distributed index

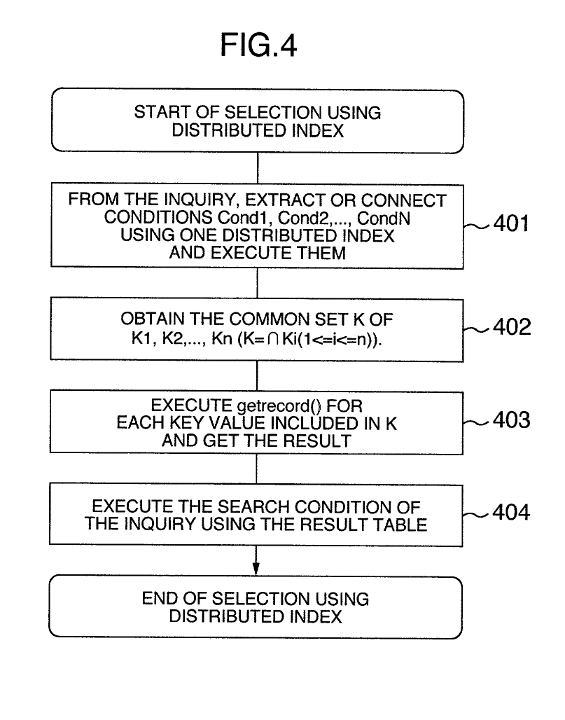

Inquiry using a distributed index is executed basically as described in the processing of the inquiry execution unit 113. One distributed index, if specified in a search condition more than once, increases efficiency. This procedure will be described with reference to FIG. 4.

In step 401, a plurality of OR connect conditions (cond1, cond2, . . . , condn) using one distributed index are obtained. These conditions, cond1, cond2, . . . , condN, are executed and the result is obtained from each condition. These results are K1, K2, . . . , Kn. K1, K2, . . . , Kn are each a set of keys of target data source of the distributed index.

In step 402, the common part K is obtained from K1, K2, . . . , Kn. Note that this common part is “INTERSECT ALL” in SQL.

In step 403, for each key included in K, getRecord(key) is issued to the target data source of the distributed index. Note that getRecord(key) is a call to the data source 107 that references the record with the key value of “key” in the target data source. The records obtained by the sequence of calls constitute a result table.

In step 404, the search condition not yet processed is executed for the result table.

The sequence of steps described above perform selection involving a plurality of OR connect conditions at a time via a distributed index and then access data source. Compared with the method in which the OR connect conditions are processed, one at a time, the number of times the data source is accessed is reduced significantly.

[5] Creation of a distributed index

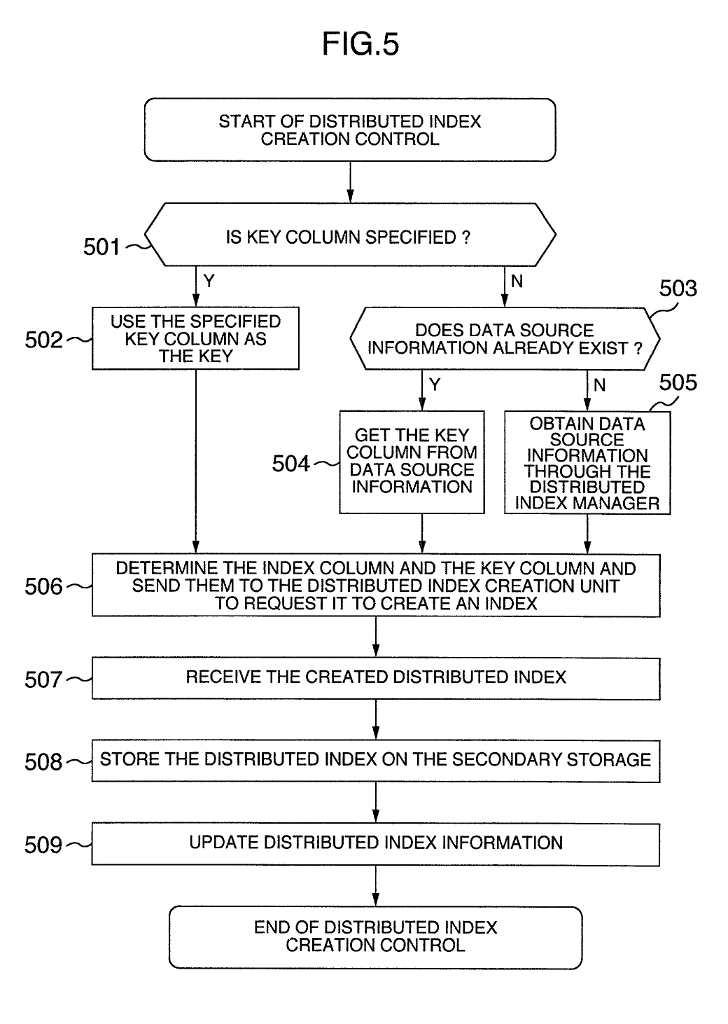

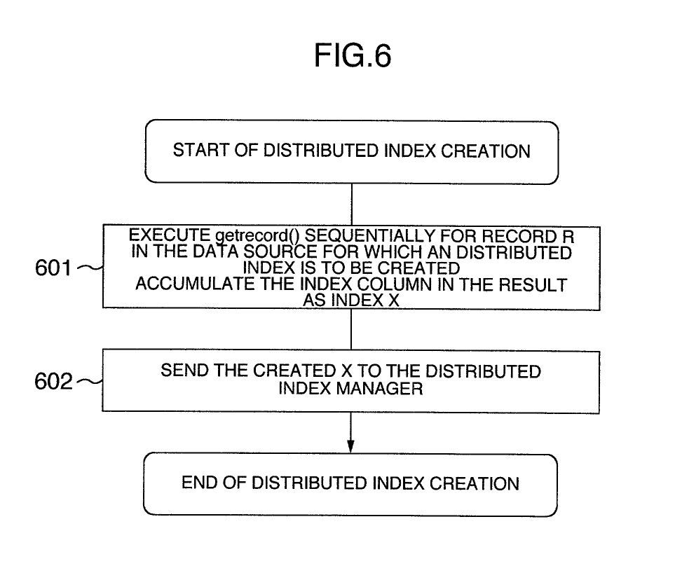

The procedure for creating a distributed index will be described with reference to FIGS. 5 and 6.

The following describes three interfaces for creating a distributed index. These interfaces, provided for use by the management application, are activated when the input/output processor 110 accepts a request from the management application and sends the accepted request to the distributed index manager 114 (160). Not that, although the application 120 and management application 121 are two separate applications in this specification, an application program with the functions of these two applications may be created.

The first interface for creating a distributed index is in the form createDistributedIndex (target data source, key column, index column). The second interface is in the form createDistributedIndex (target data source, index column) in which ‘key column’ is omitted. The third interface is in the form createDistributedIndex (target data source, index type) in which both ‘key column’ and ‘index column’ are omitted. There are three index types: “primary key priority”, “partitioning priority”, and “embedded index priority (embedded index name)”. These three types of interfaces cover a method for generating a distributed index fully specified by the manager and a method for semi-automatically generating a distributed index by the data processing system 100.

In steps 501 to 506, the three interfaces are supported. First, in step 501, control is passed to step 502 or to step 503 depending upon whether ‘key column’ is specified.

In step 502, the creation of a distributed index begins using the specified key column according to the first interface.

In step 503, control is passed to step 504 or to step 505 depending upon whether the data source information 220 that may be referenced is already in the data processing system 100. If the data source information 220 already exists, the primary key 222 of the data source information 220 is used in step 504 as the key column of the newly-created distributed index.

If the data source information 220 does not exist, the distributed index manager 114 accesses the data source to obtain key column information (and partitioning and index information if they are available). If this information cannot be obtained, an error results. And, the primary key is set in the key column.

In step 506, the index column is determined if not yet determined. The index column must be selected for the third interface. One of the primary key 222, partitioning 223, and embedded index 224 is referenced depending upon the index type “primary key priority”, “partitioning priority”, or “embedded index priority (embedded index name)” to determine the index column of the distributed index. The determined key column and the index column are sent to a distributed index creation unit 123 that exists in the data source for which the distributed index is to be created (161). For the primary key priority, a distributed index composed only of the primary keys of the data source is generated.

In step 507, the distributed index created by the distributed index creation unit 123 is stored in the secondary storage unit 115. In step 508, the distributed index information 210 is updated (or created if it does not exist). In particular, the last update date 216 is set to the current time-of-day.

On the other hand, the distributed index creation unit 123 performs the processing described below. In step 601, the distributed index creation unit 123 receives a request that is sent, in step 506, from the distributed index manager 114 and issues getRecord() for each record in the data source for which the index is to be created (162). From each of the obtained records, the unit gets a column set, which is the union of the index column and the key column, and accumulates the set in the temporary storage area as a resulting distributed index. In step 602, the unit sends the resulting distributed index to the distributed index manager 114 (163).

The distributed index creation interface and the processing procedure are as described above.

[6] Creation of a partial distributed index

In the procedure described above, the distributed index creation unit 123 creates an index for all records in the data source for which the distributed index is to be created. However, when the data source has a huge amount of data, creating the index for all records results in a large distributed index having a large amount of data. This means that the maintenance and management of such a distributed index involves high costs.

To avoid this problem, the system according to the present invention allows the user to specify a “distributed index creation condition” for the management application 121 as an option for the distributed index creation interface. This option is used as a search condition during distributed index creation.

Upon receiving a distributed index creation condition during distributed index creation, the distributed index manager 114 sends the distributed index creation condition, as well as the key column and the index column, to the distributed index creation unit 123 in the data source for which the distributed index is to be created (161).

The distributed index creation unit 123 receives this distributed index creation condition and, in step 601, issues getRecord() to the records (162). From the obtained records, the distributed index creation unit 123 extracts only the records satisfying the distributed index creation condition, obtains the column set which is the union of the index column and the key column, and accumulates the set in the temporary storage area as the resulting distributed index. This processing controls the amount of data in the resulting distributed index according to the distributed index creation condition specified by the management application 121.

As the distributed index creation condition, not only “address=‘Tokyo’” but “select X% of the whole” may be specified. When “select X% of the whole” is specified, the distributed index creation unit 123 generates random numbers to select X% from the records obtained through getRecords(). This method may be conveniently used when the index for all records is not necessarily needed, for example, when an application analyzes the statistical trends of the data contained in the data source.

[7] Selective use of a distributed index

Because the data processing system 100 maintains the distributed index independently of the update of the data source 107, there may be a temporary mismatch between the contents of the distributed index and the data in the data source 107. This sometimes requires an application to selectively use the distributed index to access the most current data. In addition, a distributed index created by specifying an option “select X% from the whole” may be suitable for a particular application such as the one analyzing the trend of the whole data but not for other applications.

To solve this problem, the system according to the present invention provides the application 120 with a method for selectively using the distributed index.

The first method for selectively using a distributed index is to specify a search condition for the last update time. This method allows an application to select a distributed index by specifying a search condition for a distributed index before or at the same time the application issues an inquiry. An example of the search condition is “make available a distributed index which was updated within last seven days” or “use a distributed index which was updated within the last seven days and which contains transaction history data”. This specification is evaluated in step 303 by the distribution index application unit 112 that selects a distributed index, and only the distributed indexes satisfying the condition are processed in step 304 and the following steps.

The second method for selectively using a distributed index is to explicitly specify the name of a distributed index. An example of the specification is “make available a distributed index whose index ID 211 is IX11”. This specification is also evaluated in step 303 by the distribution index application unit 112 that selects a distributed index, and only the distributed indexes satisfying the condition are processed in step 304 and the following steps.

The above processing enables an application to selectively use distributed indexes.

The embodiments described above have the following advantages:

A distributed index for use with the data source 107 is generated in the data processing system 100 in advance. The distribution index application unit 112 uses the distributed index to convert and disassemble an inquiry to allow an application to quickly access data sources such as data in legacy applications or tertiary storage.

The distributed index creation unit 123 located in the data source 107 prevents heavy communication traffic during distributed index creation. This significantly reduces the network load. The reduction in the network load, in turn, greatly reduces the network processing load of a computer where data source is stored.

The data processing system 100 provides an index update interface to allow the distributed index creation unit 123 to create a distributed index in response to an index update request. This interface timely updates the distributed index. The interface allowing the user to specify whether to use a distributed index or which distributed index to use enables an appropriate distributed index to be used selectively.

As the distributed index, the distribution index application unit 112 uses a distributed index for a part of the records in the data source. This makes it possible to reduce the amount of data in the distributed index and to create a distributed index for a data source with a large amount of data.

When integrating the information base of a plurality of DBMSs in a company or between companies, the present invention, with the effect described above, integrates data whether data is stored in a relational database management system or in data sources such as legacy application programs or tertiary storage where inquiry cannot be executed efficiently. This advantage allows an application to quickly access those data sources.

While the present invention has been particularly described and shown with reference to the preferred embodiments thereof, it will be understood by those skilled in the art that various changes in form and detail and omissions may be made without departing from the scope of the invention. For example, the present invention may be implemented by a storage medium storing therein a program executing the data access method described above, and the storage medium is also included in the scope of the invention. In addition, the present invention may be implemented by a recording medium recording therein a program executing the distributed index creation method described above, and the recording medium is also included in the scope of the invention.

What is claimed is:

1. A data access method for use in a computer system in which a first computer and a second computer are connected via a network, in which secondary storage of said second computer contains first data composed of a plurality of records each composed of one or more columns, in which a first program accepting an inquiry issued from an application program to the first data is prepared in said first computer, and in which a second program performing input/output of the first data is prepared in said second computer,
wherein the inquiry accepted by said first program includes a first search condition for one or more columns included in the first data,
wherein said first program extracts a distributed index from the first data before the inquiry is accepted and maintains the distributed index, said distributed index indicating a correspondence between an index column composed of columns which are a part of records of the first data and a key column composed of columns which are arguments used to access said second program,
converts the first search condition included in the inquiry upon accepting the inquiry and obtains from the distributed index a key column of records satisfying the first search condition, and
accesses the first data using the key column via the second program to obtain the records satisfying the first search condition and returns the records to the application program as a result of the inquiry.

2. The data access method according to claim 1, wherein said distributed index comprises a plurality of records and each column of the plurality of records includes a union of the index column and the key column.

3. The data access method according to claim 1, wherein the key column of the records satisfying the first search condition is obtained by extracting a condition from the converted first search condition, the condition being able to be evaluated by the index column and the key column the distributed index.

4. The data access method according to claim 1, wherein said distributed index includes data indicating a correspondence between the index column and the key column of records satisfying a second search condition.

5. A data access method for use in a computer system in which a first computer and a second computer are connected via a network, in which secondary storage of said second computer contains first data composed of a plurality of records each composed of one or more columns, in which a first program accepting an inquiry issued from an application program to the first data is prepared in said first computer, and in which a second program performing input/output of the first data is prepared in said second computer,
wherein said first program extracts a plurality of distributed indexes from the first data and maintains the distributed indexes, each of said plurality of distributed indexes indicating a correspondence between an index column composed of columns which are a part of records of the first data and a key column composed of columns which are arguments used to access said second program,
wherein the application program issues the inquiry including a first search condition for one or more columns included in the first data, as well as information specifying a permitted distributed index that may be used in the inquiry, said permitted distributed index being one of the plurality of distributed indexes, and
wherein, upon accepting the inquiry, said first program converts the first search condition included in the inquiry and obtains, from the permitted distributed index, a key column of the records satisfying the first search condition, and
accesses the first data using the key column via the second program to obtain the records satisfying the first search condition and returns the records to the application program as a result of the inquiry.

6. The data access method according to claim 5, wherein the application program specifies a range of a last update time of the distributed index to specify the permitted distributed index that may be used in the inquiry.

7. The data access method according to claim 5, wherein the application program specifies an identifier identifying the distributed index to specify the permitted distributed index that may be used in the inquiry.

8. A storage medium storing therein a program executing the data access method according to claim 1.

9. A storage medium storing therein a program executing the data access method according to claim 5.

10. A distributed index creation method for creating a distributed index used for accessing first data and stored in a first computer, said method being used in a computer system in which said first computer and a second computer are connected via a network, in which secondary storage of said second computer contains the first data composed of a plurality of records each composed of one or more columns, in which a first program accepting an inquiry issued from an application program to the first data is prepared in said first computer, and in which a second program performing input/output of the first data is prepared in said second computer,
wherein a distributed index creation program prepared in said second computer accepts a distributed index creation request from said first program, and
wherein said distributed index creation program obtains a correspondence between an index column composed of columns which are a part of records of the first data for which said distributed index is to be created and a key column composed of columns which are arguments used by said second program to access the first data, and
returns an obtained result to said first program.

11. The distributed index creation method according to claim 10, wherein said distributed index creation program receives a target data source, a key column, and an index column as settings and creates, from the data source, the distributed index including the key column and the index column.

12. The distributed index creation method according to claim 10, wherein said distributed index creation program receives a distributed index creation condition as a setting, applies the distributed index creation condition to said first data to select records for which the distributed index is to be created, and creates the distributed index.

13. The distributed index creation method according to claim 10, wherein said distributed index creation program receives a ratio of a number of records to be included in the distributed index to a number of records included in the first data and selects records according to the ratio specified for the first data to create the distributed index.

14. A recording medium recording therein a program executing the distributed index creation method according to claim 10.

15. The distributed index creation method according to claim 10, wherein said first program records the returned distributed index, as well and an update date thereof, on a storage unit of said first computer.

16. A distributed index creation method for use in a computer system in which a first computer and a second computer are connected via a network, in which secondary storage of said second computer contains first data composed of a plurality of records each composed of one or more columns, in which a first program accepting an inquiry issued from an application program to the first data is prepared in said first computer, in which a second program performing input/output of the first data is prepared in said second computer, in which said first computer maintains a distributed index indicating a correspondence between an index column composed of first columns which are a part of records of the first data and a key column composed of second columns which are arguments used to access said second program, and in which, when the inquiry is accepted, said first program obtains a key column of records satisfying the inquiry from the distributed index and accesses the first data using the key column via the second program,
wherein, when a request to create said distributed index is received from the application program, said first program references data source information on the first data to determine an index column and a key column and creates said distributed index with the determined index column and the key column specified for the distributed index creation program prepared in said second computer.

17. A recording medium recording therein a program executing the distributed index creation method according to claim 16.
